(19) United States
(12) Patent Application Publication
(10) Pub. No.: US 2026/0290397 A1
(43) Pub. Date: Sep. 24, 2026

(54) MAGNETIC DISK DEVICE AND DATA RECORDING METHOD

(71) Applicants: Kabushiki Kaisha Toshiba, Kawasaki (JP); Toshiba Electronic Devices & Storage Corporation, Kawasaki (JP)

(72) Inventor: Satoru FUKASE, Fujisawa Kanagawa (JP)

(21) Appl. No.: 19/305,439

(22) Filed: Aug. 20, 2025

(30) Foreign Application Priority Data
Mar. 19, 2025 (JP) 2025-045748

(51) Int. Cl. G11B 20/18; G11B 19/04; G11B 20/12

(52) U.S. Cl. CPC G11B 20/1889; G11B 19/045; G11B 20/1217; G11B 2020/1222

(57) ABSTRACT

A magnetic disk device according to an embodiment includes a magnetic disk, a magnetic head, and a controller. On the magnetic disk, tracks including a first track and a second track are provided. The second track is radially adjacent to the first track and is subjected to writing prior to the first track. The first/second tracks each include data sectors. The data sectors include a data sector in which a parity is stored. The parity is an error correction code for error correction in units of track. The controller controls the magnetic head when performing reading and writing on the data sector in response to a command from a host. The controller dynamically allocates the parity in a case where there is a possibility that the data sector causes an error when the magnetic head performs reading and writing on the data sector.

### CROSS-REFERENCE TO RELATED APPLICATIONS

This application is based upon and claims the benefit of priority from Japanese Patent Application No. 2025-045748, filed on March 19, 2025; the entire contents of which are incorporated herein by reference.

### FIELD

Embodiments described herein relate generally to a magnetic disk device and a data recording method.

### BACKGROUND

There is a magnetic disk device having a function of protecting written data in units of track. With this function, the magnetic disk device can generate an error correction code for each of the tracks and perform error correction in units of track based on the error correction code. The error correction for each track is referred to as parity.

A magnetic disk device having a function of the parity is configured to monitor the position of a magnetic head during writing operation. There is a possibility that, when writing to a write target track is being performed, data in an adjacent track cannot be corrected even with the parity. In such a case, the magnetic disk device interrupts the writing operation and executes a predetermined operation.

In the conventional magnetic disk device described above, an upper limit of the number of sectors correctable with the parity at the time of a read error is predetermined. However, it is necessary to avoid losing data when an error exceeding the upper limit occurs and thereby error correction cannot be sufficiently performed.

Therefore, there is a need to suppress the above-described data loss and improve data reliability.

### BRIEF DESCRIPTION OF THE DRAWINGS

FIG. 1 is a schematic diagram illustrating an example of a configuration of a magnetic disk device according to an embodiment.

FIG. 2 is a schematic diagram illustrating an example of a configuration of a magnetic disk according to the embodiment.

FIG. 3 is a schematic diagram for describing an SMR scheme used in the magnetic disk device according to the embodiment.

FIG. 4 is a diagram illustrating an example for describing track error correction according to the embodiment.

FIG. 5 is a diagram illustrating an example for describing a case in which a track error occurs at the time of performing writing according to the embodiment.

FIG. 6 is a diagram illustrating an example for describing first processing about a series of writing process according to the embodiment.

FIG. 7 is a diagram illustrating an example for describing writing process after the processing described with reference to FIG. 6 according to the embodiment.

FIG. 8 is a diagram illustrating an example for describing writing process after the processing described with reference to FIG. 7 according to the embodiment.

FIG. 9 is a diagram illustrating an example for describing writing process after the processing described with reference to FIG. 8 according to the embodiment.

FIG. 10 is a diagram illustrating an example of a configuration of data stored in a parity allocated anew according to the embodiment.

FIG. 11 is a flowchart illustrating an example of a method of data writing process in the magnetic disk device according to the embodiment.

### DETAILED DESCRIPTION

A magnetic disk device according to the present embodiment is a magnetic disk device connected to a host. The magnetic disk device includes a magnetic disk, a magnetic head, and a controller. On the magnetic disk, tracks including a first track and a second track are provided. The second track is radially adjacent to the first track and is subjected to writing prior to the first track. The first track and the second track each include data sectors. The data sectors includes a data sector in which a parity is stored. The parity is an error correction code for error correction in units of track. The magnetic head is configured to write data and read data to and from the magnetic disk. The controller is configured to control the magnetic head when performing reading and writing on the data sector in response to a command from the host. The controller is configured to dynamically allocate the parity in a case where there is a possibility that the data sector causes an error when the magnetic head performs reading and writing on the data sector.

A magnetic disk devices according to an embodiment will be described in detail below with reference to the accompanying drawings. Note that the present disclosure is not limited by the embodiment.

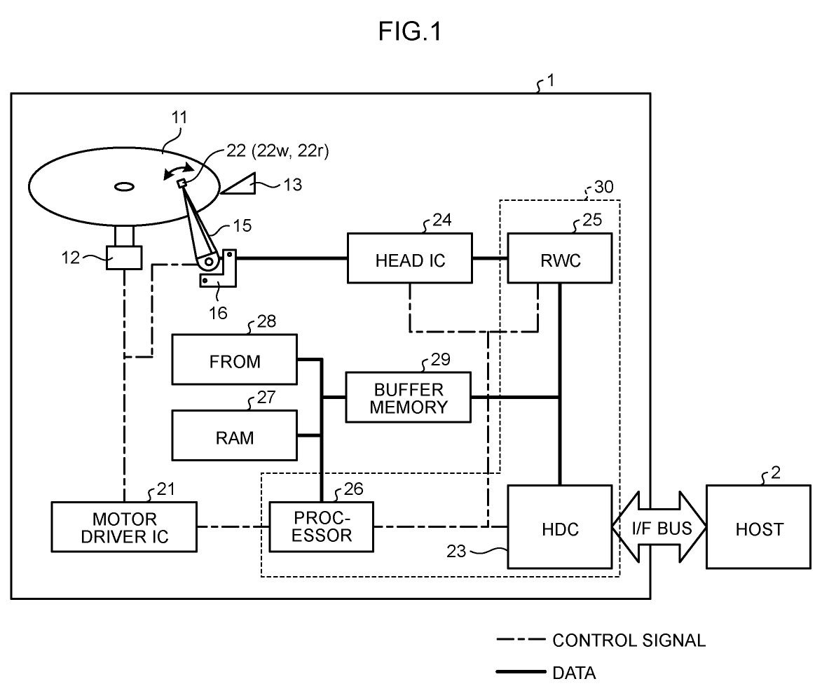

FIG. 1 is a schematic diagram illustrating an example of a configuration of the magnetic disk device according to the present embodiment. A magnetic disk device 1 is connected to a host 2. The magnetic disk device 1 can receive access commands such as a write command and a read command from the host 2.

The magnetic disk device 1 includes a magnetic disk 11 on which a recording surface is formed. The magnetic disk device 1 performs writing data and reading data on the magnetic disk 11 (more accurately, the recording surface of the magnetic disk 11) in response to the access commands. Note that the magnetic disk device 1 can include a plurality of magnetic disks 11. However, in the present embodiment, for simplification of description and illustration, the magnetic disk device 1 includes one magnetic disk 11.

The writing and reading of data are performed via a magnetic head 22. In addition to the magnetic disk 11, the magnetic disk device 1 includes a spindle motor 12, a motor driver IC (Integrated Circuit) 21, a magnetic head 22, an actuator arm 15, a voice coil motor (VCM) 16, a ramp 13, a head IC 24, a read/write channel (RWC) 25, a RAM 27, a FROM (Flash Read Only Memory) 28, a buffer memory 29, a hard disk controller (HDC) 23, and a processor 26.

The magnetic disk 11 is rotated at predetermined rotation speed by a spindle motor 12 attached to a rotation shaft of the magnetic disk 11. The spindle motor 12 is driven by the motor driver IC 21.

The motor driver IC 21 controls rotation of the spindle motor 12 and rotation of the VCM 16.

The magnetic head 22 writes data and reads data to and from the magnetic disk 11 with a write element 22w and a read element 22r of the magnetic head 22. The magnetic head 22 is attached to the distal end of the actuator arm 15. The magnetic head 22 is moved in the radial direction of the magnetic disk 11 by the VCM 16 driven by the motor driver IC 21.

When, for example, the rotation of the magnetic disk 11 is stopped, the magnetic head 22 is moved onto the ramp 13. The ramp 13 is configured to hold the magnetic head 22 at a position separated from the magnetic disk 11.

The head IC 24 amplifies and outputs a signal read from the magnetic disk 11 by the magnetic head 22 at the time of a reading operation and supplies the signal to the RWC 25. The head IC 24 amplifies a signal corresponding to the write target data supplied from the RWC 25 and supplies the amplified signal to the magnetic head 22 at the time of a writing operation.

The HDC 23 performs control of transmission and reception of data performed with the host 2 via an I/F bus, control of the buffer memory 29, and the like.

The buffer memory 29 is used as a buffer for data transmitted to and received from the host 2. For example, the buffer memory 29 is used for temporarily storing data to be written in the magnetic disk 11 or data read from the magnetic disk 11.

The buffer memory 29 is implemented by, for example, a volatile memory capable of performing a high-speed operation. A type of a memory configuring the buffer memory 29 is not limited to a specific type. The buffer memory 29 is, for example, a DRAM (Dynamic Random Access Memory) or a SRAM (Static Random Access Memory), or a combination the DRAM and the SRAM.

The RWC 25 performs modulation including error correction coding on write target data supplied from the HDC 23 and supplies the modulated data to the head IC 24. The RWC 25 performs demodulation including error correction on a signal read from the magnetic disk 11 and supplied from the head IC 24 and outputs digital data obtained by the demodulation to the HDC 23.

The processor 26 may be a CPU (Central Processing Unit). The RAM 27, the FROM (Flash Read Only Memory) 28, and the buffer memory 29 are connected to the processor 26.

The FROM 28 is a nonvolatile memory. The FROM 28 stores firmware (program data), various operation parameters, and the like. Note that the firmware may be stored in the magnetic disk 11.

The RAM 27 is implemented by, for example, a DRAM, an SRAM, or a combination of the DRAM and the SRAM. The RAM 27 is used as a memory for operation by the processor 26. The RAM 27 is used as a region to which the firmware is loaded and a region where various kinds of management data are stored.

The processor 26 performs overall control for the magnetic disk device 1 according to the firmware stored in the FROM 28 or the magnetic disk 11. For example, the processor 26 loads the firmware from the FROM 28 or the magnetic disk 11 to the RAM 27 and executes control of the motor driver IC 21, the head IC 24, the RWC 25, the HDC 23, and the like according to the loaded firmware.

Note that a configuration including the RWC 25, the processor 26, and the HDC 23 can also be regarded as the controller 30. The controller 30 performs control at the time when reading in and writing from a data sector by the magnetic head 22 are performed. The controller 30 is sometimes configured as an SoC (System-On-a-Chip). The controller 30 may not always be configured as the SoC. In addition to these elements, the controller 30 may include other elements (for example, the RAM 27, the FROM 28, the buffer memory 29, and the RWC 25).

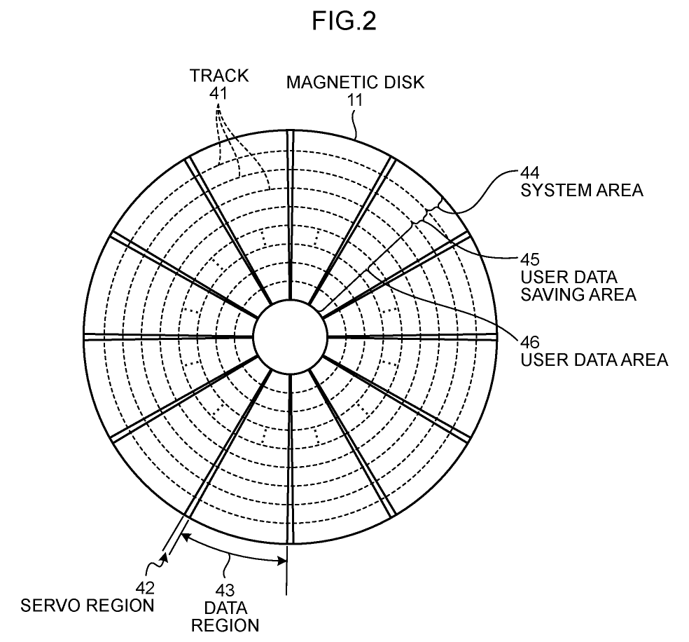

FIG. 2 is a schematic diagram illustrating an example of a configuration of the magnetic disk according to the present embodiment.

Servo information is written in the magnetic disk 11 by, for example, a servo writer or self-servo write (SSW) in a manufacturing process. FIG. 2 illustrates servo regions 42 radially arranged as an example of arrangement of servo regions in which the servo information is written. Data regions 43 in which data can be written are provided among the servo regions 42.

In the radial direction of the magnetic disk 11, concentric tracks 41 are provided based on the servo information. Data sectors in which data is to be written are arranged in the data regions 43 provided along the track 41.

The servo information includes a servo mark, a gray code, a burst pattern, and a post code. When writing data in a data sector or reading data from a data sector, the controller 30 generates a positional error signal (PES) based on servo information read from the servo region 42 by the magnetic head 22. The PES indicates an amount of deviation from a target track. The controller 30 executes positioning for the magnetic head 22, that is, seek control and tracking control based on a PES acquired every time the magnetic head 22 passes over the servo region 42.

The magnetic disk 11 in the present embodiment includes a system area 44, a user data saving area 45, and a user data area 46. The system area 44 is located in the track 41 on the outermost circumferential side among the three data areas. The system area 44 is a data area in which system information about the magnetic disk device 1 is stored. The user data area 46 is located in the track 41 on the innermost circumferential side among the three data areas. The user data area 46 is a data area where the magnetic head 22 performs reading and writing of data. The user data saving area 45 is provided in a track 41 that is located between the system area 44 and the user data area 46. The user data saving area 45 is a data area where data stored in a data sector in the user data area 46 is saved in a case where there is a possibility that an error occurs in this data sector when the magnetic head 22 performs reading and writing on the user data area 46.

For a scheme of writing data on the magnetic disk 11, a scheme called SMR scheme (Shingled Magnetic Recording) and a scheme called CMR scheme (Conventional Magnetic Recording) have been known. The present embodiment is assumed to apply the SMR scheme.

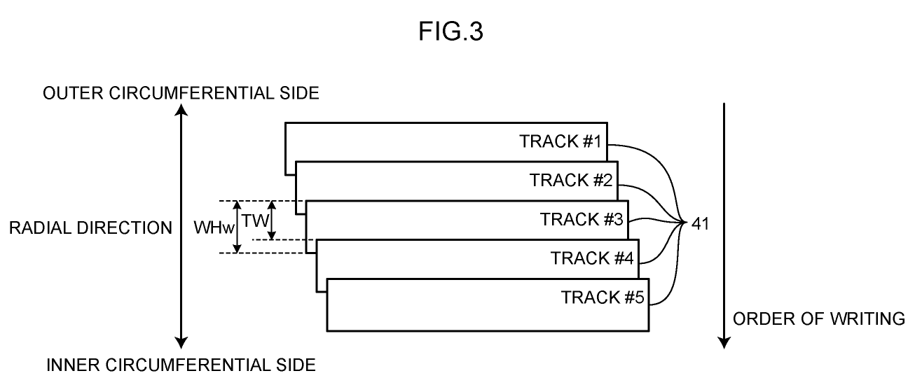

FIG. 3 is a schematic diagram for describing the SMR scheme used in the magnetic disk device according to the present embodiment. In the SMR scheme, in a case of writing data (referred to as first data) in a track 41 and thereafter writing data (referred to as second data) in a track 41 radially adjacent to the former track 41, the tracks 41 are arranged such that the second data overlaps part of the first data. Thus, according to the SMR scheme, data for one of the two tracks 41 adjacent to each other in the radial direction of the magnetic disk 11 is written so as to be superimposed on part of data in the other one of the two tracks 41.

Specifically, data for a track #2 (an example of the first track) is written so as to overlap with part of data already written in a track #1 (an example of the second track). Data for a track #3 is written so as to overlap with part of data already written in the track #2. According to the SMR scheme, processing of overlapping data for a track onto part of data already written in an adjacent track is repeated.

Accordingly, track widths TW are narrowed to be smaller than the width (WHw) of the write element 22w and recording density is improved.

However, when the writing operation for a write target track 41 is executed, the magnetic head 22 sometimes vibrates due to an external factor. When the magnetic head 22 deviates toward an adjacent track 41 that is adjacent to the write target track 41 and is subjected to data writing prior to the write target track 41, the width of the adjacent track 41 is narrowed by an amount of deviation of the magnetic head 22 toward the adjacent track 41. In a case where the amount of the width of the adjacent track 41 reduced by the deviation of the magnetic head 22 toward the adjacent track is larger than a predetermined amount, a magnetic field of the magnetic head 22 interferes with the data written in the adjacent track. Is such a case, the data written in the adjacent track may be lost. Moreover, according to the SMR scheme, the track width TW is narrower compared with a track width of the CMR scheme or the like. Therefore, the data in the adjacent track is greatly affected by the vibration of the magnetic head 22.

In the present embodiment, when the controller 30 is writing data in a data sector of the track 41, the controller 30 determines whether an amount of the width of the adjacent track, which is reduced by the deviation of the magnetic head 22 toward the adjacent track, is larger than the predetermined amount. With this determination, the controller 30 estimates whether the data stored in the adjacent track is likely to be lost, in other words, whether there is a possibility that a track error occurs.

The controller 30 according to the present embodiment has the parity that is used for a function to perform track error correction. With the parity, even if data written in some data sectors of the adjacent track has been lost due to vibration of the magnetic head 22, the lost data can be restored by the error correction.

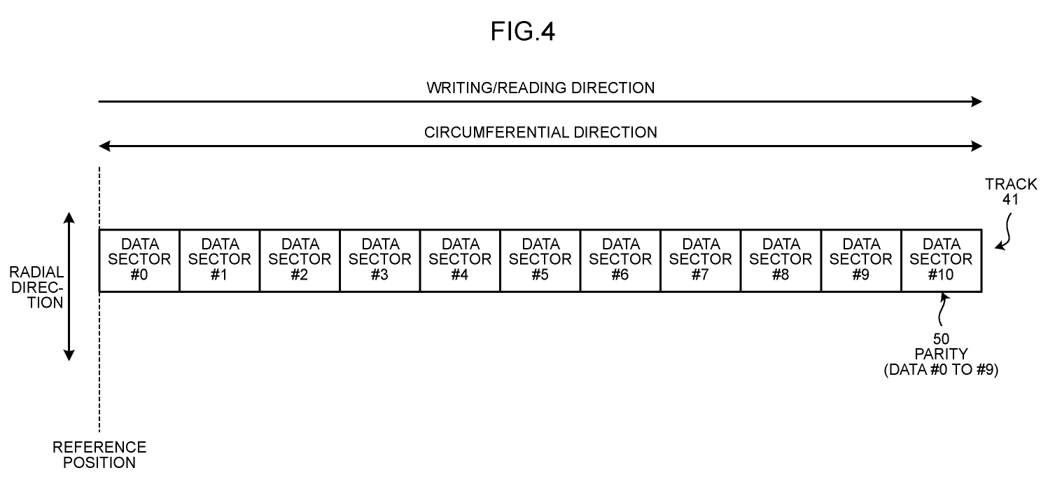

FIG. 4 is a diagram illustrating an example for describing track error correction according to the present embodiment. In FIG. 4, a configuration of one track 41 is illustrated, whereas servo sectors are not illustrated. In FIG. 4, a writing/reading direction is illustrated. The writing/reading direction is a direction in which the magnetic head 22 moves relative to the track 41 by the rotation of the magnetic disk 11. The magnetic head 22 writes data in or reads data from the tracks 41 in the writing/reading direction.

The data sectors provided in the track 41 are identified by sector numbers. A data sector whose sector number is x is referred to as data sector #x. In the example illustrated in FIG. 4, the track 41 includes eleven data sectors of a data sector #0 to a data sector #10.

The eleven data sectors are arrayed in the order of sector numbers in the writing/reading direction from a reference position in the circumferential direction. In FIG. 4, the head and the end are defined based on the reference position and the writing/reading direction.

Specifically, a position where the magnetic head 22 firstly passes over in a section from when the magnetic head 22 passes over the reference position to when the magnetic head 22 passes over the reference position next is referred to as a track head. A position where the magnetic head 22 finally passes over in the above-mentioned section is referred to as a track end. Among the data sector #0 to the data sector #10, the data sector #0 that is located at the track head is referred to as a head data sector. Among the data sector #0 to the data sector #10, the data sector #10 that is located at the track end is referred to as an end data sector.

The end data sector #10 is a data sector in which a parity 50 is to be stored. The parity 50 is an error correction code for track error correction. Writing of data in units of the tracks 41 is executed as follows. First, data is written in the data sector #0 to the data sector #9 in this order of the sector numbers. The parity 50, which is calculated based on a data group written in the data sector #0 to the data sector #9, is written in the end data sector #10 of the track 41.

The parity 50 written in the data sector #10 protects the data group written in the data sector #0 to the data sector #9 from occurrence of error. Thus, the parity 50 written in the sector #10 protects data in units of track.

Note that a method of calculating the parity 50 is not limited to a specific method. In one example, the parity 50 is generated by executing XOR for each bit position on the data group written in the data sector #0 to the data sector #9.

As described above, the data sectors including a data sector for the parity 50 are provided in each track 41. Note that the number of data sectors for parities 50 provided in each track 41 is not limited to one. For example, two data sectors for parities may be provided in each track 41. In this case, for example, in one of the two data sectors for parities, a parity generated from a data group written in data sectors located at an even-numbered position from the track head is stored. In the other one of the two data sectors for parities, a parity generated from a data group written in data sectors located at an odd-numbered position from the track head is stored. Alternatively, three or more data sectors for parities may be provided in each track 41.

During the writing operation, while continuing the writing operation, the controller 30 estimates whether a track error occurs in the method described with reference to FIG. 3. The track error is caused by the situation that data in an adjacent track cannot be corrected even with the parity 50. In response to estimating that a track error occurs due to continuation of the writing operation, the controller 30 interrupts the writing operation and executes a predetermined operation.

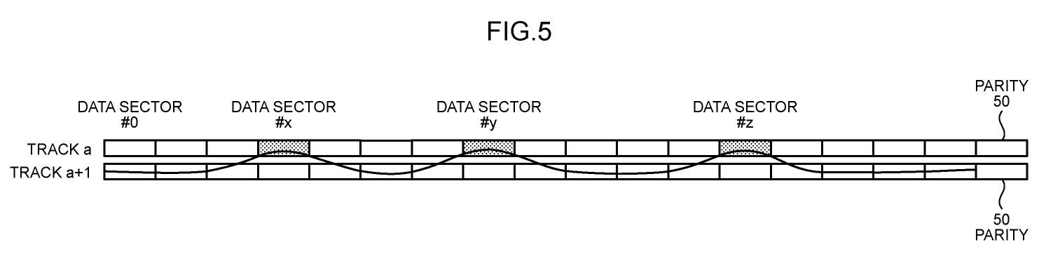

FIG. 5 is a diagram illustrating an example for describing a case in which a track error occurs at the time of performing writing according to the present embodiment. In FIG. 5, when the controller 30 performs writing in the track 41 (a track a+1: an example of the first track), writing may be performed due to an external factor such as a system fan, an off-track, or the like described with reference to FIG. 3. In such a case, there is sometimes influence such as data inscription of data sectors (data sectors #x, #y, and #z: an example of a specific data sector) of the adjacent track 41 (a track a: an example of the second track). As a result, a read error is detected from the affected data sector and retry is required for data recovery on the affected data sector. The parity 50 is added as the parity 50 targeting data in all data sectors in the track 41 and is used for data correction at the time of retry of reading on the track. However, the parity 50 has an upper limit of data correctable sectors. Additionally, in a case where the large number of errors occur, those errors cannot be corrected and, as a result, user data is to be lost.

In the present embodiment, considering a writing status of the adjacent track 41, the loss of the data described above can be prevented by newly allocating a parity 51 to an optional data sector on a track out of data sectors for reading and writing data. Hereinafter, details of the method will be described.

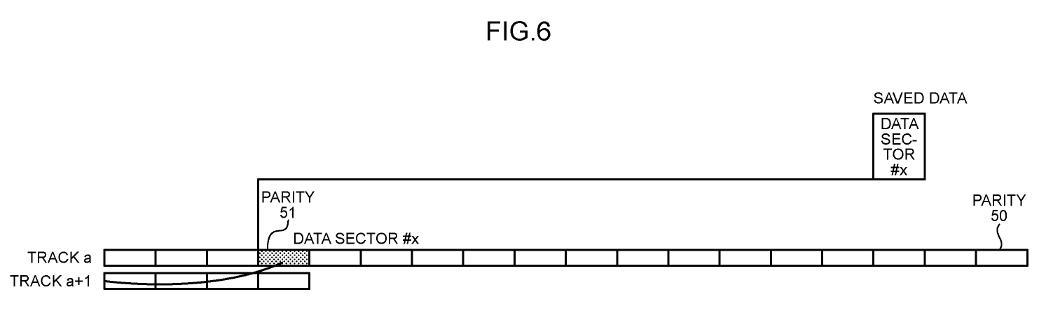

FIG. 6 is a diagram illustrating an example for describing first processing about a series of writing process according to the present embodiment. In FIG. 6, the writing process for the track 41 (track a+1) is performed from a data sector at the left end toward the right. The controller 30 interrupts the writing process when the controller 30 estimates that a track error will occur in the data sector #x of the adjacent track 41 (track a) due to an external factor as described with reference to FIG. 3.

Then, the controller 30 saves, in the user data saving area 45, data stored in the data sector #x of the adjacent track 41 (track a). At this time, even if a read error occurs in the data sector #x, it is less likely that the saved data cannot be read because error correction with the parity 50 is possible.

After saving the data of the data sector #x in the user data saving area 45, the controller 30 allocates the parity 51 to this data sector #x. The stored data of the data sector #x is saved in the user data saving area 45, whereas the stored data may be saved in any predetermined data area as long as such an area can be identified on the magnetic disk device 1.

With the parity 51, data correction is performed at the time when a read error or the like occurs in the data sector #0, which is a reference position at the left end, to the data sector #x.

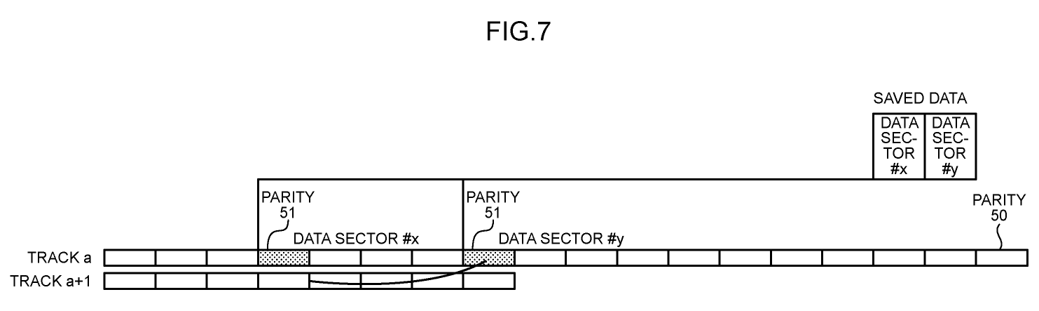

FIG. 7 is a diagram illustrating an example for describing writing process after the processing described with reference to FIG. 6 according to the present embodiment. In FIG. 6, after allocating the parity 51 to the data sector #x, the controller 30 resumes the interrupted writing process on the write target track 41 (track a+1).

When the controller 30 estimates that a track error will occur in the data sector #y of the adjacent track (track a) while the writing process is continuously performed, the controller interrupts the writing process again and saves data of the data sector #y in the user data saving area 45. Then, the controller 30 newly allocates the parity 51 to the data sector #y. The parity 51 allocated anew is used for performing data correction from the data sector #x to the data sector #y of the adjacent track (track a).

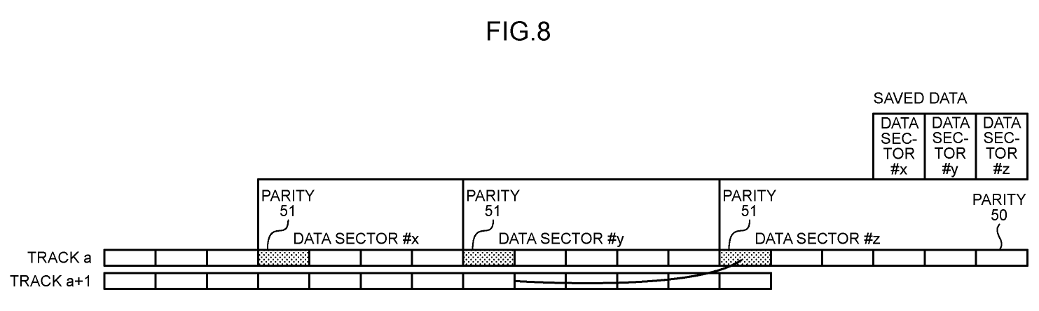

FIG. 8 is a diagram illustrating an example for describing writing process after the processing described in FIG. 7 according to the present embodiment. After allocating the parity 51 to the data sector #y of the adjacent track (track a), the controller 30 resumes the writing of the write target track 41 (track a+1) again. Also when the controller 30 estimates that the track error will occur in the data sector #z of the adjacent track 41 (track a), the writing process is interrupted, and the data of the data sector #z is saved in the user data saving area 45. Then, the controller 30 newly allocates the parity 51 to the data sector #z, and this parity 51 is used for performing data correction from the data sector #y to the data sector #z of the adjacent track (track a).

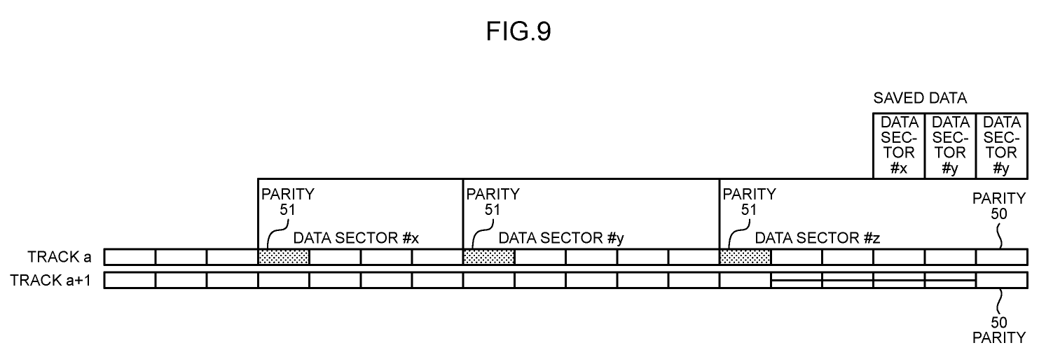

FIG. 9 is a diagram illustrating an example for describing writing process after the processing described in FIG. 8 according to the present embodiment. After the controller 30 allocates the parity 51 to the data sector #z of the adjacent track (track a) as in FIG. 8, the controller 30 resumes the interrupted writing process on the write target track 41 (track a+1) and completes the writing process for this track 41 (track a+1).

As described with reference to FIGS. 6 to 9, while executing the writing process on the write target track 41, the controller 30 dynamically allocates the parity 51 anew every time estimating that a track error is likely to occur. Specifically, while performing writing on the write target track 41 (track a+1), every time estimating that a track error will occur in a data sector of the adjacent track 41 (track a), the controller 30 repeatedly performs processing of interrupting the writing process on the write target track 41 (track a+1), saving data of a data sector of the adjacent track 41 (track a) in the user data saving area 45, and allocating the parity 51 to the data sector of the adjacent track 41 (track a).

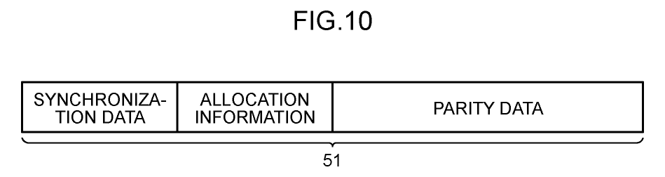

FIG. 10 is a diagram illustrating an example of a configuration of data stored in a parity allocated anew according to the present embodiment. The parity 51 allocated by the controller 30 mainly includes synchronization data, allocation information, and parity data.

The synchronous data is information serving as a reference indicating a start position of a data sector. The controller 30 detects this data when performing reading of data in order to recognize that necessary data is present.

The allocation information is data indicating position information about a saving destination of data stored in a data sector before the parity 51 is newly allocated.

The parity data is data effective for recognizing that the parity 51 is allocated anew by the controller 30.

By detecting the parity data from a data sector, the controller 30 can recognize that the parity 51 is allocated to this data sector and performs reading of the saved data based on the allocation information.

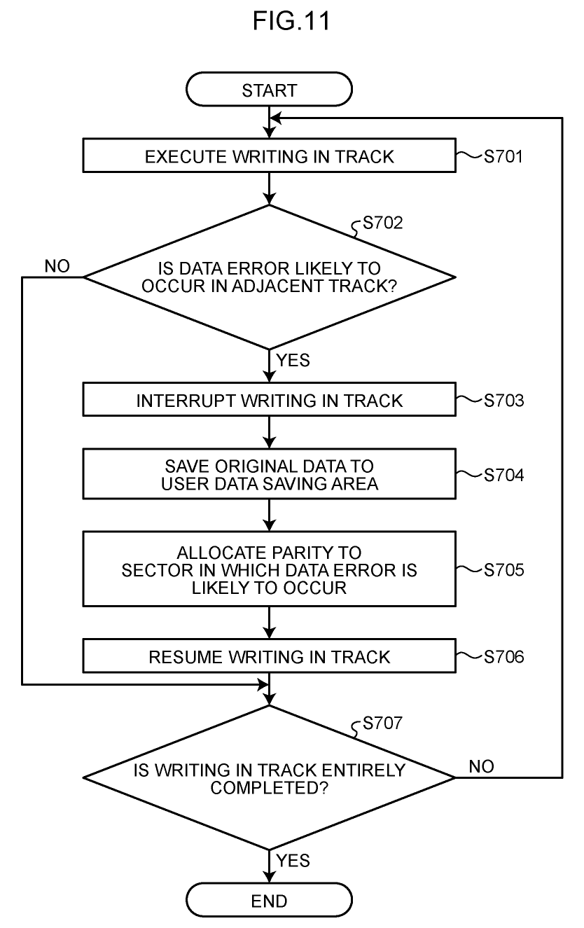

FIG. 11 is a flowchart illustrating an example of a method of data writing process in the magnetic disk device according to the present embodiment. First, the controller 30 performs writing in a target track 41 (S701). Then, while continuing the writing in the write target track 41, the controller 30 estimates whether a track error is likely to occur in a data sector of an adjacent track 41 due to an external factor described with reference to FIG. 3 (S702).

In response to estimating that a track error is likely to occur in the data sector of the adjacent track 41 (S702: Yes), the controller 30 interrupts the writing process for the write target track 41 (S703).

Subsequently, the controller 30 saves, in the user data saving area 45, original data stored in the data sector of the adjacent track 41, which is estimated that a track error is likely to occur (S704).

Subsequently, the controller 30 allocates the parity 51 anew to the data sector of the adjacent track 41, which is estimated that a track error will occur (S705).

Subsequently, the controller 30 resumes the interrupted writing process on the write target track 41 (S706).

When the controller 30 does not estimate that a track error will occur in the data sector of the adjacent track 41 (S702: No), the controller 30 continues the writing process on the write target track 41.

Then, the controller 30 checks whether the writing process for the write target track 41 has been entirely completed (S707). When the writing process has not been completed (S707: No), the controller 30 performs the processing in S701 to S706 again. When the writing process for the write target track 41 has been completed (S707: Yes), the controller 30 ends the processing.

In a magnetic disk device in a comparative example, there is a case that correction cannot be performed even by using the parity. However, in the related art, the parities are arranged in the predetermined number in fixed sectors on each track and arrangement positions and the number of sectors for the parities are not changed with a use situation.

In contrast, according to the magnetic disk device 1 of the present embodiment, when the magnetic head 22 performs reading and writing on a data sector in the target track on the magnetic disk 11, the controller 30 dynamically allocates the parity 51 when a data sector of the adjacent track is likely to cause an error. With this configuration, plural parities 51 can be optionally allocated to one track. Therefore, data correction is enabled even in a situation that a data sector exceeding the correction capability of one parity 50 causes a read error.

When the magnetic head 22 performs reading and writing on a data sector of the write target track 41, the magnetic disk device 1 according to the present embodiment estimates whether an error occurs based on an amount of deviation toward an adjacent track from the target track on which the magnetic head 22 is performing reading and writing. Accordingly, the controller 30 can prevent data loss due to a track error and can take subsequent processing.

In response to estimating that a track error is likely to occur in a data sector of the adjacent track 41, the magnetic disk device 1 according to the present embodiment interrupts the writing process for the write target track 41 being executed. Accordingly, the controller 30 can prevent a read error from occurring and can take subsequent processing.

In response to estimating that a track error is likely to occur in a data sector of the adjacent track 41, the magnetic disk device 1 according to the present embodiment saves, in a predetermined data area (45), data stored in the data sector of the adjacent track 41. Accordingly, before the data in the data sector of the adjacent track 41 causes a read error and the data is lost, the magnetic disk device 1 can prevent the data from being lost by saving the data in the predetermined data area.

In the magnetic disk device 1 according to the present embodiment, after the controller 30 estimates that a track error is likely to occur in a data sector of the adjacent track 41 and saves data thereof in the predetermined data area, the controller 30 allocates the parity 51 to the data sector of the adjacent track 41. Accordingly, the data sector in which a track error is likely to occur can be effectively utilized without being wasted.

In addition, in the magnetic disk device 1 according to the present embodiment, after the controller 30 allocates the parity 51 to a data sector of the adjacent track 41, the allocated parity 51 is used for performing data correction from a data sector at a reference position of the track 41 to the data sector to which the parity 51 is allocated. Accordingly, the data sector in which a track error is likely to occur can be effectively utilized without being wasted, leading to improvement of the reliability of data because the error correction capability of the entire track 41 is also improved.

When the controller 30 estimates that a track error is likely to occur in a data sector of the adjacent track 41, the magnetic disk device 1 according to the present embodiment repeatedly performs processing every time a track error occurs. The processing includes: interrupting writing process on the write target track 41 being executed, saving, in a predetermined data area, data in a data sector of the adjacent track in which a track error is likely to occur, setting the parity 51 to the data sector in which a track error is likely to occur, and performing, based on the parity 51, data correction from data sector of the previous parity 51 to a data sector of the current parity 51. Accordingly, even in a situation that an error occurs in plural data sectors exceeding the correction capability of one parity 50, prevention of loss of the data is enabled because the data correction capability is improved by the other allocated parity 51.

In the magnetic disk device 1 according to the present embodiment, the data sector for the parity 51 includes position information about original data saved in the user data saving area 45 and information for determining that the parity 51 is newly allocated to the data sector. The controller 30 recognizes data for determining that the parity 51 is newly allocated to the data sector and performs reading of the saved original data based on position information that is a saving destination of the original data. Accordingly, even if a track error occurs, data loss can be prevented and data stored in a data sector in which a track error is likely to occur can be read.

In the present embodiment, concerning a method of estimating whether a track error is likely to occur, the estimation is performed based on an amount of deviation from a target track to be written by the magnetic head 22 toward an adjacent track. However, the method is not limited thereto. The present embodiment can also be applied by a track error estimation method by another method.

In the present embodiment, the original data stored in the parity 51 is saved in the user data saving area 45, when the controller 30 reads the parity 51, the controller 30 recognizes data for determining that the parity 51 is allocated stored in the parity 51 and performs read of the saved original data based on position information about the saved original data. However, the method is not limited thereto. For example, the present embodiment can be applied to a method other than the method described above if the original data stored in the parity 51 allocated anew can be read.

In the present embodiment, the user data saving area 45 is provided as a track adjacent to each of the system area 44 and the user data area 46. However, the arrangement of the user data saving area 45 is not limited thereto as long as it is provided between the system area 44 and the user data area 46. For example, the user data saving area 45 may be provided between the system area 44 and the user data area 46 while interposing another area between the areas 44 and 46.

In the present embodiment, the system area 44 is provided on the outermost circumference of the magnetic disk 11, the user data saving area 45 is provided on the immediate inner circumference side from the system area 44, and the user data area 46 is provided on the immediate inner circumference side from the user data saving area 45 but the areas are not limited thereto. For example, when the system area 44 is provided on the innermost circumference of the magnetic disk 11, the user data saving area 45 may be provided on a track on the immediate outer circumferential side from the system area 44 and the user data area 46 may be provided on a track on the immediate inner circumferential side from the user data saving area 45.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device connected to a host, the magnetic disk device comprising:
a magnetic disk on which tracks including a first track and a second track are provided, the second track being radially adjacent to the first track and being subjected to writing prior to the first track, the first track and the second track each including data sectors, the data sectors includes a data sector in which a parity is stored, the parity being an error correction code for error correction in units of track;
a magnetic head configured to write data and read data to and from the magnetic disk; and
a controller configured to
control the magnetic head when performing reading and writing on the data sector in response to a command from the host, and
dynamically allocate the parity in a case where there is a possibility that the data sector causes an error when the magnetic head performs reading and writing on the data sector.

2. The magnetic disk device according to claim 1, wherein the controller is configured to estimate whether there is a possibility that an error occurs in a specific data sector in the second track when the magnetic head performs reading and writing on the data sector of the first track, the possibility of the error being estimated based on an amount of deviation of the magnetic head from the first track toward the second track.

3. The magnetic disk device according to claim 2, wherein the controller is configured to interrupt writing in the first track being executed in response to estimating that there is the possibility that an error occurs in the specific data sector in the second track.

4. The magnetic disk device according to claim 3, wherein the controller is configured to save, in a predetermined data area on the magnetic disk, original data stored in the specific data sector in the second track in response to estimating that there is the possibility that an error occurs in the specific data sector in the second track.

5. The magnetic disk device according to claim 4, wherein the predetermined data area on the magnetic disk is located between
a data area to be subjected to writing data and reading data, and
a data area in which system information about the magnetic disk device is stored.

6. The magnetic disk device according to claim 4, wherein the controller is configured to allocate the parity to the specific data sector in the second track after saving the original data in the predetermined data area.

7. The magnetic disk device according to claim 6, wherein the controller is configured to, after allocating the parity to the specific data sector, perform data correction based on the parity from a data sector at a reference position in the second track to the specific data sector in the second track.

8. The magnetic disk device according to claim 7, wherein the controller is configured to
resume writing in the first track after allocating the parity to the specific data sector in the second track, and,
in response to estimating that there is a possibility that a track error occurs in another data sector of the second track, repeat processing every time the track error occurs, the processing to be repeated including:
interrupting again writing in the first track;
saving, in the predetermined data area, data in a data sector where there is the possibility that the track error occurs;
allocating the parity to the data sector where there is the possibility that the track error occurs; and
performing, based on the parity, data correction from the specific data sector to which the parity was allocated last time to the data sector to which the parity is allocated this time.

9. The magnetic disk device according to claim 8, wherein
the parity includes
position information about the predetermined data area in which the original data is saved, and
data for determining that the parity is newly allocated, and
the controller is configured to
recognize the data for determining that the parity is newly allocated, and
perform reading of the saved original data based on the position information included in the parity.

10. A data recording method implemented by a magnetic disk device, the magnetic disk device including a magnetic disk on which tracks including a first track and a second track are provided, the second track being radially adjacent to the first track and being subjected to writing prior to the first track, the first track and the second track each including data sectors, the data sectors includes a data sector in which a parity is stored, the parity being an error correction code for error correction in units of track, the data recording method comprising:
receiving a command from a host; and
performing reading and writing on the data sector by a magnetic head in response to the command, the performing including
estimating whether there is a possibility that the data sector causes an error, and
dynamically allocating the parity in response to estimating that there is the possibility that the data sector causes an error.

11. The data recording method according to claim 10, wherein the estimating includes estimating whether there is a possibility that an error occurs in a specific data sector in the second track when the magnetic head performs reading and writing on the data sector of the first track, the possibility of the error being estimated based on an amount of deviation of the magnetic head from the first track toward the second track.

12. The data recording method according to claim 11, further comprising interrupting writing in the first track being executed in response to estimating that there is the possibility that an error occurs in the specific data sector in the second track.

13. The data recording method according to claim 12, further comprising saving, in a predetermined data area on the magnetic disk, original data stored in the specific data sector in the second track in response to estimating that there is the possibility that an error occurs in the specific data sector in the second track.

14. The data recording method according to claim 13, wherein the predetermined data area on the magnetic disk is located between
a data area to be subjected to writing data and reading data, and
a data area in which system information about the magnetic disk device is stored.

15. The data recording method according to claim 13, wherein the dynamically allocating the parity is performed by allocating the parity to the specific data sector in the second track after saving the original data in the predetermined data area.

16. The data recording method according to claim 15, wherein further comprising, in response to allocating the parity to the specific data sector, performing data correction based on the parity from a data sector at a reference position in the second track to the specific data sector in the second track.

17. The data recording method according to claim 16, further comprising
resuming writing in the first track in response to allocating the parity to the specific data sector in the second track, and,
in response to estimating that there is a possibility that a track error occurs in another data sector of the second track, repeating processing every time the track error occurs, the processing to be repeated including:
interrupting again writing in the first track;
saving, in the predetermined data area, data in a data sector where there is the possibility that the track error occurs;
allocating the parity to the data sector where there is the possibility that the track error occurs; and
performing, based on the parity, data correction from the specific data sector to which the parity was allocated last time to the data sector to which the parity is allocated this time.

18. The data recording method according to claim 17, wherein
the parity includes
position information about the predetermined data area in which the original data is saved, and
data for determining that the parity is newly allocated, and
the data recording method further comprises:
recognizing the data for determining that the parity is newly allocated; and
performing reading of the saved original data based on the position information included in the parity.
